(19) United States
(12) Patent Application Publication
(10) Pub. No.: US 2010/0251250 A1
(43) Pub. Date: Sep. 30, 2010

(54) LOCK-FREE SCHEDULER WITH PRIORITY SUPPORT

(75) Inventors: Arun U. Kishan, Bellevue, WA (US); Thomas D. I. Fahrig, Redmond, WA (US); Rene Antonio Vega, Kirkland, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 12/414,454

(22) Filed: Mar. 30, 2009

(51) Int. Cl. G06F 9/46

(52) U.S. Cl. 718/103

(57) ABSTRACT

Techniques for implementing a lock-free scheduler with ordering support are described herein. In addition to the foregoing, other aspects are described in the claims, drawings, and text forming a part of the present disclosure. It can be appreciated by one of skill in the art that one or more various aspects of the disclosure may include but are not limited to circuitry and/or programming for effecting the herein-referenced aspects of the present disclosure; the circuitry and/or programming can be virtually any combination of hardware, software, and/or firmware configured to effect the herein-referenced aspects depending upon the design choices of the system designer.

### BACKGROUND

Generally, in a multiprocessor system a scheduler can schedule threads for execution on logical processors. The scheduler can maintain a list of threads to execute in order of priority and when a processor is free, the scheduler can schedule the next thread to run on the free processor. Each processor can concurrently add/remove from the scheduler's list and a synchronization primitive such as a lock is generally needed in order to synchronize the actions between various processors. As the number of processors increases in the system so do the collisions on the lock. Generally, when a processor attempts to acquire the lock when it is held by another processor the processor waits for the lock to become free. Thus, processor cycles are wasted. In a virtualized environment, e.g., one in which the hardware resources are shared between multiple partitions, designers strive to schedule threads at a faster rate than in conventional computer systems because each virtual machine must simulate a physical machine. Since virtual machine activity corresponds to virtual processor runtime virtual processors are scheduled at a high frequency to ensure reasonable latency for events. Accordingly, in a virtualized environment the problem of collisions on the lock becomes more acute. Thus, techniques for reducing the amount of processor cycles spend trying to schedule a thread are desirable.

### SUMMARY

An example embodiment of the present disclosure describes a method. In this example, the method includes, but is not limited to storing a thread in a linked list associated with a specific processor of a plurality of processors in a computer system, the linked list accessible to the plurality of processors; adding the thread stored in the linked list to a ready list associated with the specific processor, the ready list is only accessible to the specific processor and the threads are stored in the ready list in an order of priority; and executing the thread. In addition to the foregoing, other aspects are described in the claims, drawings, and text forming a part of the present disclosure.

An example embodiment of the present disclosure describes a method. In this example, the method includes, but is not limited to determining that a linked list for a processor is empty, the linked list configured to store threads; adding a thread to the linked list and sending an interrupt to the processor; determining that the thread was added to the linked list for the processor in response to receiving the interrupt; determining that the thread was added to the linked list for the processor in response to receiving the interrupt; and adding the thread to a ready list for the processor, the processor configured to execute threads from the ready list in an order of thread priority, and the ready list is exclusively accessible by the processor. In addition to the foregoing, other aspects are described in the claims, drawings, and text forming a part of the present disclosure.

An example embodiment of the present disclosure describes a method. In this example, the method includes, but is not limited to entering, by a processor, an idle state, wherein the processor is configured to monitor a memory address associated with a linked list while in the idle state; detecting, by the processor, that a thread was added to the linked list and exiting the idle state; and adding the thread to a ready list for the processor, the processor configured to execute threads from the ready list in an order of priority and the ready list is exclusively accessible by the processor. In addition to the foregoing, other aspects are described in the claims, drawings, and text forming a part of the present disclosure.

It can be appreciated by one of skill in the art that one or more various aspects of the disclosure may include but are not limited to circuitry and/or programming for effecting the herein-referenced aspects of the present disclosure; the circuitry and/or programming can be virtually any combination of hardware, software, and/or firmware configured to effect the herein-referenced aspects depending upon the design choices of the system designer.

The foregoing is a summary and thus contains, by necessity, simplifications, generalizations and omissions of detail. Those skilled in the art will appreciate that the summary is illustrative only and is not intended to be in any way limiting.

### BRIEF DESCRIPTION OF THE DRAWINGS

FIG. 1 depicts an example computer system wherein aspects of the present disclosure can be implemented.

FIG. 2 depicts an operational environment for practicing aspects of the present disclosure.

FIG. 3 depicts an operational environment for practicing aspects of the present disclosure.

FIG. 4 depicts an example scheduler that can be used to practice aspects of the present disclosure.

FIG. 5 depicts operational procedure for practicing aspects of the present disclosure.

FIG. 6 depicts an alternative embodiment of the operational procedure of FIG. 5.

FIG. 7 depicts operational procedure for practicing aspects of the present disclosure.

FIG. 8 depicts an alternative embodiment of the operational procedure of FIG. 7.

FIG. 9 depicts an alternative embodiment of the operational procedure of FIG. 8.

FIG. 10 depicts operational procedure for practicing aspects of the present disclosure.

FIG. 11 depicts an alternative embodiment of the operational procedure of FIG. 10.

FIG. 12 depicts an alternative embodiment of the operational procedure of FIG. 11.

FIG. 13 depicts an alternative embodiment of the operational procedure of FIG. 11.

FIG. 14 depicts an alternative embodiment of the operational procedure of FIG. 11.

### DETAILED DESCRIPTION

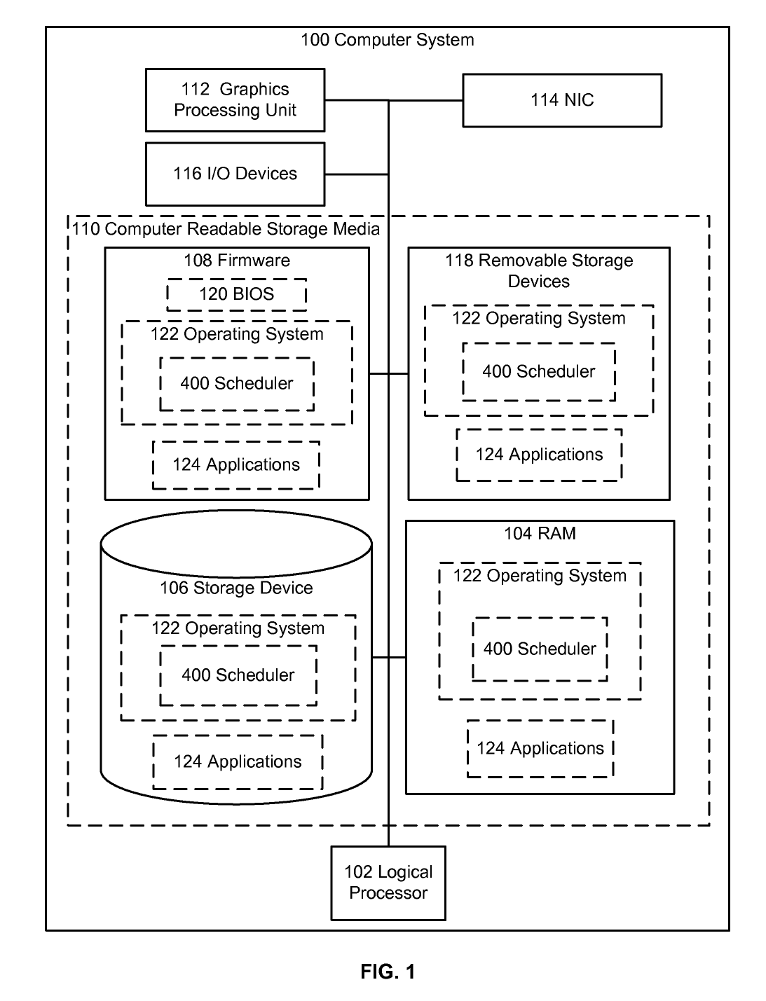

Embodiments may execute on one or more computers. FIG. 1 and the following discussion are intended to provide a brief general description of a suitable computing environment in which the disclosure may be implemented. One skilled in the art can appreciate that computer systems 200, 300 can have some or all of the components described with respect to computer 100 of FIG. 1.

The term circuitry used throughout the disclosure can include hardware components such as hardware interrupt controllers, hard drives, network adaptors, graphics processors, hardware based video/audio codecs, and the firmware/software used to operate such hardware. The term circuitry can also include microprocessors configured to perform function(s) by firmware or by switches set in a certain way or one or more logical processors, e.g., one or more cores of a multi-core general processing unit. The logical processor(s) in this example can be configured by software instructions embodying logic operable to perform function(s) that are loaded from memory, e.g., RAM, ROM, firmware, and/or virtual memory. In example embodiments where circuitry includes a combination of hardware and software an implementer may write source code embodying logic that is subsequently compiled into machine readable code that can be executed by a logical processor. Since one skilled in the art can appreciate that the state of the art has evolved to a point where there is little difference between hardware, software, or a combination of hardware/software, the selection of hardware versus software to effectuate functions is merely a design choice. Thus, since one of skill in the art can appreciate that a software process can be transformed into an equivalent hardware structure, and a hardware structure can itself be transformed into an equivalent software process, the selection of a hardware implementation versus a software implementation is trivial and left to an implementer.

Referring now to FIG. 1, an exemplary computing system 100 is depicted. Computer system 100 can include a logical processor 102, e.g., an execution core. While one logical processor 102 is illustrated, in other embodiments computer system 100 may have multiple logical processors, e.g., multiple execution cores per processor substrate and/or multiple processor substrates that could each have multiple execution cores. As shown by the figure, various computer readable storage media 110 can be interconnected by a system bus which couples various system components to the logical processor 102. The system bus may be any of several types of bus structures including a memory bus or memory controller, a peripheral bus, and a local bus using any of a variety of bus architectures. In example embodiments the computer readable storage media 110 can include for example, random access memory (RAM) 104, storage device 106, e.g., electromechanical hard drive, solid state hard drive, etc., firmware 108, e.g., FLASH RAM or ROM, and removable storage devices 118 such as, for example, CD-ROMs, floppy disks, DVDs, FLASH drives, external storage devices, etc. It should be appreciated by those skilled in the art that other types of computer readable storage media which can store data that is accessible by a computer, such as magnetic cassettes, flash memory cards, digital video disks, Bernoulli cartridges.

The computer readable storage media provide non volatile storage of computer readable instructions, data structures, program modules and other data for the computer 100. A basic input/output system (BIOS) 120, containing the basic routines that help to transfer information between elements within the computer system 100, such as during start up, can be stored in firmware 108. A number of programs may be stored on firmware 108, storage device 106, RAM 104, and/or removable storage devices 118, and executed by logical processor 102 including an operating system 122, one or more application programs 124.

Commands and information may be received by computer 100 through one or more input devices 116 which can include, but are not limited to, a keyboard and pointing device. Other input devices may include a microphone, joystick, game pad, scanner or the like. These and other input devices are often connected to the logical processor 102 through a serial port interface that is coupled to the system bus, but may be connected by other interfaces, such as a parallel port, game port or universal serial bus (USB). A display or other type of display device can also be connected to the system bus via an interface, such as a video adapter which can be part of, or connected to, a graphics processor 112. In addition to the display, computers typically include other peripheral output devices (not shown), such as speakers and printers. The exemplary system of FIG. 1 can also include a host adapter, Small Computer System Interface (SCSI) bus, and an external storage device connected to the SCSI bus.

Computer system 100 may operate in a networked environment using logical connections to one or more remote computers, such as a remote computer. The remote computer may be another computer, a server, a router, a network PC, a peer device or other common network node, and typically can include many or all of the elements described above relative to computer system 100.

When used in a LAN or WAN networking environment, computer system 100 can be connected to the LAN or WAN through a network interface card 114. The NIC 114, which may be internal or external, can be connected to the system bus. In a networked environment, program modules depicted relative to the computer system 100, or portions thereof, may be stored in the remote memory storage device. It will be appreciated that the network connections described here are exemplary and other means of establishing a communications link between the computers may be used. Moreover, while it is envisioned that numerous embodiments of the present disclosure are particularly well-suited for computerized systems, nothing in this document is intended to limit the disclosure to such embodiments.

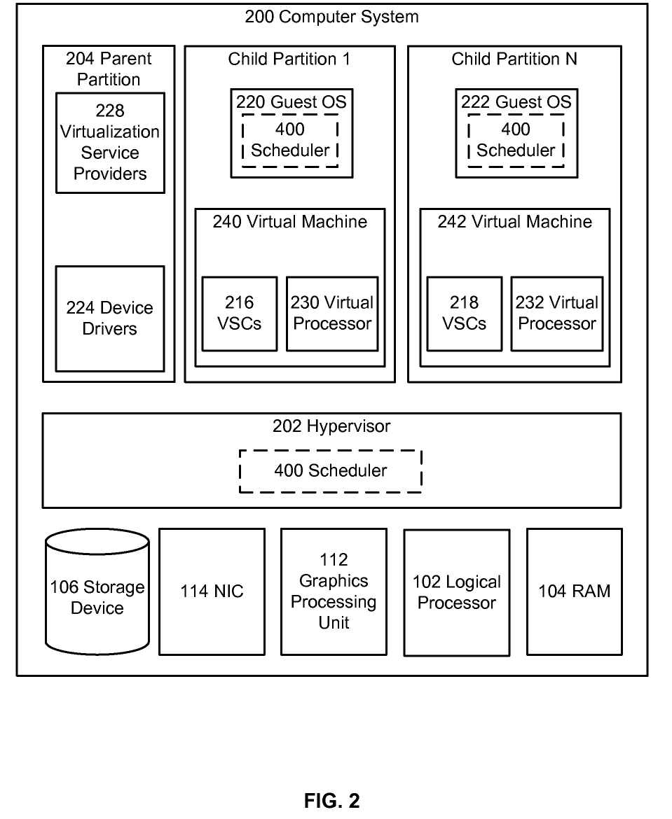

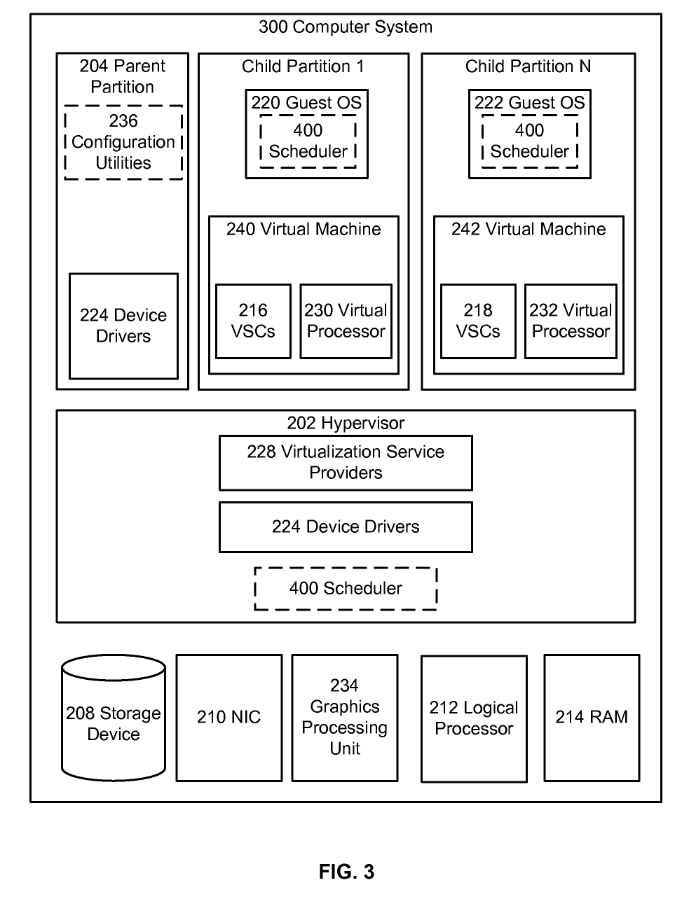

Referring now to FIGS. 2 and 3, they depict high level block diagrams of computer systems. As shown by the figure, computer system 200 can include physical hardware devices such as those described with respect to FIG. 1. Continuing with the description of FIG. 2, depicted is a hypervisor 202 that may also be referred to in the art as a virtual machine monitor. Hypervisor 202 in the depicted embodiment includes executable instructions for controlling and arbitrating access to the hardware of computer system 200. Broadly, hypervisor 202 can generate execution environments called partitions such as child partition 1 through child partition N (where N is an integer greater than 1). In embodiments a child partition can be considered the basic unit of isolation supported by the hypervisor 202, that is, each child partition can be mapped to a set of hardware resources, e.g., memory, devices, logical processor cycles, etc., that is under control of hypervisor 202 and/or parent partition 204. In embodiments hypervisor 202 can be a stand-alone software product, a part of an operating system, embedded within firmware of the motherboard, specialized integrated circuits, or a combination thereof.

In the depicted example computer system 200 includes a parent partition 204 that can be configured to provide resources to guest operating systems executing in the child partitions 1-N by using virtualization service providers 228 (VSPs). In this example architecture parent partition 204 can gate access to the underlying hardware. Broadly, VSPs 228 can be used to multiplex the interfaces to the hardware resources by way of virtualization service clients (VSCs). Each child partition can include one or more virtual processors such as virtual processors 230 through 232 that guest operating systems 220 through 222 can manage and schedule threads to execute thereon. Generally, virtual processors 230 through 232 are executable instructions and associated state information that provide a representation of a physical processor with a specific architecture. For example, one virtual machine may have a virtual processor having characteristics of an Intel x86 processor, whereas another virtual processor may have the characteristics of a PowerPC processor. The virtual processors in this example can be mapped to logical processor 102 of computer system 200 such that the instructions that effectuate the virtual processors will be backed by logical processors. Thus, in these example embodiments, multiple virtual processors can be simultaneously executing while, for example, another logical processor is executing hypervisor instructions. Generally speaking, and as illustrated by the figure, the combination of virtual processors and various VSCs in a partition can be considered a virtual machine such as virtual machine 240 or 242.

Generally, guest operating systems 220 through 222 can be the same or similar to guest operating system 108 and can include any operating system such as, for example, operating systems from Microsoft®, Apple®, the open source community, etc. The guest operating systems can include user/kernel modes of operation and can have kernels that can include schedulers, memory managers, etc. Each guest operating system 220 through 222 can have associated file systems that can have applications stored thereon such as e-commerce servers, email servers, etc., and the guest operating systems themselves. The guest operating systems 220-222 can schedule threads to execute on the virtual processors 230-232 and instances of such applications can be effectuated.

Referring now to FIG. 3, it illustrates an alternative architecture that can be used. FIG. 3 depicts similar components to those of FIG. 2, however in this example embodiment hypervisor 202 can include virtualization service providers 228 and device drivers 224, and parent partition 204 may contain configuration utilities 236. In this architecture hypervisor 202 can perform the same or similar functions as the hypervisor 202 of FIG. 2. Hypervisor 202 of FIG. 3 can be a stand alone software product, a part of an operating system, embedded within firmware of the motherboard or a portion of hypervisor 202 can be effectuated by specialized integrated circuits. In this example parent partition 204 may have instructions that can be used to configure hypervisor 202 however hardware access requests may be handled by the hypervisor 202 instead of being passed to the parent partition 204.

As shown by FIGS. 1, 2, and 3, in example embodiments a scheduler 400 can be integrated within the instructions that effectuate operating system 122, guest operating systems 220, 222, and/or hypervisor 202. In other embodiments scheduler 400 can be integrated within firmware 108.

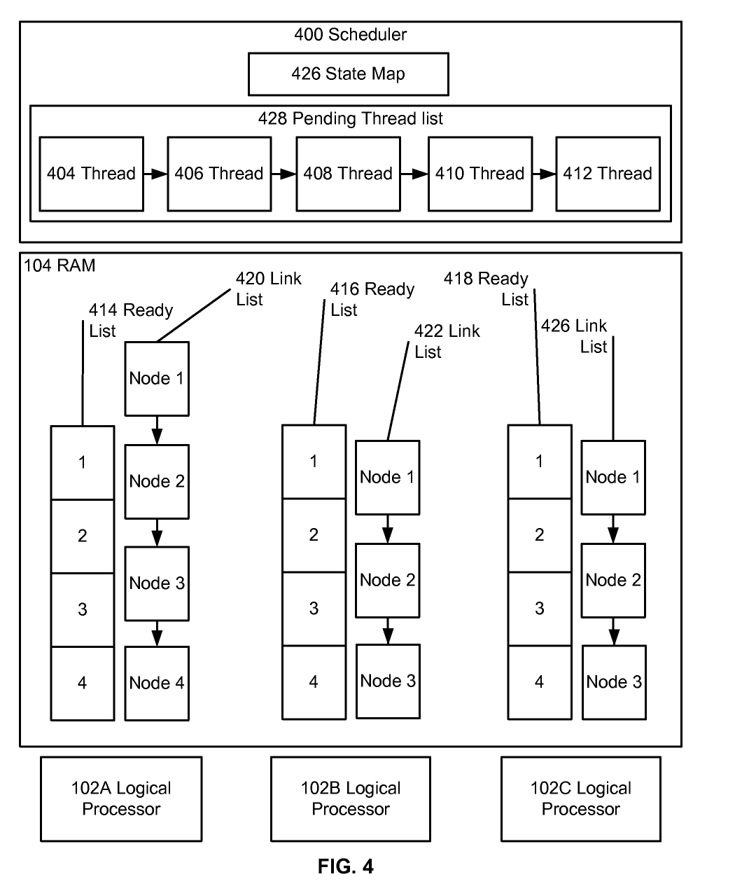

Turning now to FIG. 4, it depicts a scheduler 400. Scheduler 400 can comprise processor executable instructions that can be processed by a logical processor such as logical processor 102A, B, or C, and configure the logical processor to schedule pending threads 404-412 in thread list 428 to run on logical processors 102A-C. In this example, threads 404 can include hypervisor threads or operating system threads (depending on where scheduler 400 is effectuated). As shown by the figure, scheduler 400 can include a state map 426 which can include information that identifies the state of each logical processor in the computer system. In an embodiment when a logical processor runs the scheduler instructions it can schedule threads to execute on processors by storing threads 404-412 in a data structures in RAM 104. Each logical processor can be associated with data structures such as a ready list (414-418) and a linked list (420-424).

Generally, in embodiments of the present disclosure a ready list is a per-processor data structure that stores threads, i.e., memory addresses for threads awaiting execution, in an order of priority. When the processor associated with the ready list finishes executing a thread, it executes the next thread and so on and so forth. In this example, the threads in the ready list can be ordered by priority relative to any other threads in the ready list. In order to avoid having to use synchronization locks, the ready list can be exclusively accessed by the processor that is associated with it. That is, in an embodiment a processor can not access a ready list associated with a different processor.

Linked lists are also per-processor data structures that stores threads, except that the linked lists can be accessed by any processor in the computer system individually or at the same time and any processor can add threads to the linked lists. Generally, in an embodiment each linked list can include a singly-linked list made up of nodes. Also, as shown by the figure, each processor can have a different amount of nodes in their linked list depending on how the processor is being used. Each node can be configured to store a thread, e.g., the thread's priority and the thread's memory address, and point to the node that immediately preceded it. The last node in the list can point to a null or other sentinel value. Each processor can be configured to add nodes to the head of the linked lists which in turn pushes the prior nodes down the lists. For example, linked list 420 is depicted as including 4 nodes. If processor 102B added a thread to linked list 420, a 5^{th} node would be created and it would become the node 1. In this embodiment the linked lists can be used to store threads that have been assigned to processors, but have not yet been ordered based on priority. Since the linked list of ready threads is not concurrently accessed by other processors ordering is not important and synchronization locks are not needed.

The following are a series of flowcharts depicting implementations of processes. For ease of understanding, the flowcharts are organized such that the initial flowcharts present implementations via an overall “big picture” viewpoint and subsequent flowcharts provide further additions and/or details. Furthermore, one of skill in the art can appreciate that the operational procedure depicted by dashed lines are considered optional.

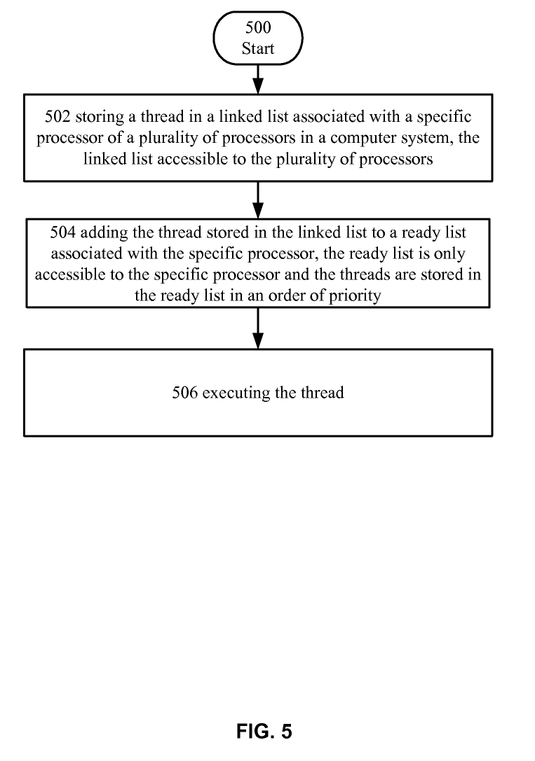

Turning now to FIG. 5, it depicts an operational procedure for practicing aspects of the present disclosure including operations 500, 502, 504, and 506. As shown by the figure, operation 500 begins the operational procedure and operation 502 depicts storing a thread in a linked list associated with a specific processor of a plurality of processors in a computer system, the linked list accessible to the plurality of processors. Referring to FIG. 4 a logical processor, such as logical processor 102A can execute scheduler instructions and add thread 404, e.g., a memory address for the thread and/or the thread's priority, to a linked list for, for example processor 102C. In this example logical processor 102A can generate a node structure in RAM 104 add the thread information to the node. The node can then be linked to the linked list 426 at the head. That is, thread 404 will be placed in a new node that will become node 1 of linked list 426.

Continuing with the description of FIG. 5, operation 504 illustrates adding the thread stored in the linked list to a ready list associated with the specific processor, the ready list is only accessible to the specific processor and the threads are stored in the ready list in an order of priority. Referring again to FIG. 4 logical processor associated with linked list 426, e.g., logical processor 102C, can access linked list 426 and insert the thread into ready list 418 based on its priority relative to any other threads on ready list 418. For example, logical processor 102C can execute scheduler instructions and identify the priority of the threads in ready list 418. Logical processor 102C can then insert thread 404 into the list behind higher priority threads and in front of lower priority threads. In a specific situation, thread 404 may be the highest priority thread compared to other threads in ready list 418 and can be inserted into position 1 on ready list 418.

Continuing with the description of FIG. 5, operation 506 shows executing the thread. In this example logical processor 102C can execute thread 404 from ready list 418. Thread 404 may have been the highest thread in ready list 418, thus, it could have been executed when logical processor 102C exits from running the scheduler instructions. In another situation thread 404 may have had a lower priority than three other threads in ready list 418 and thus could have been stored in position 4. Logical processor 102C may have then executed the three threads before it executed thread 404.

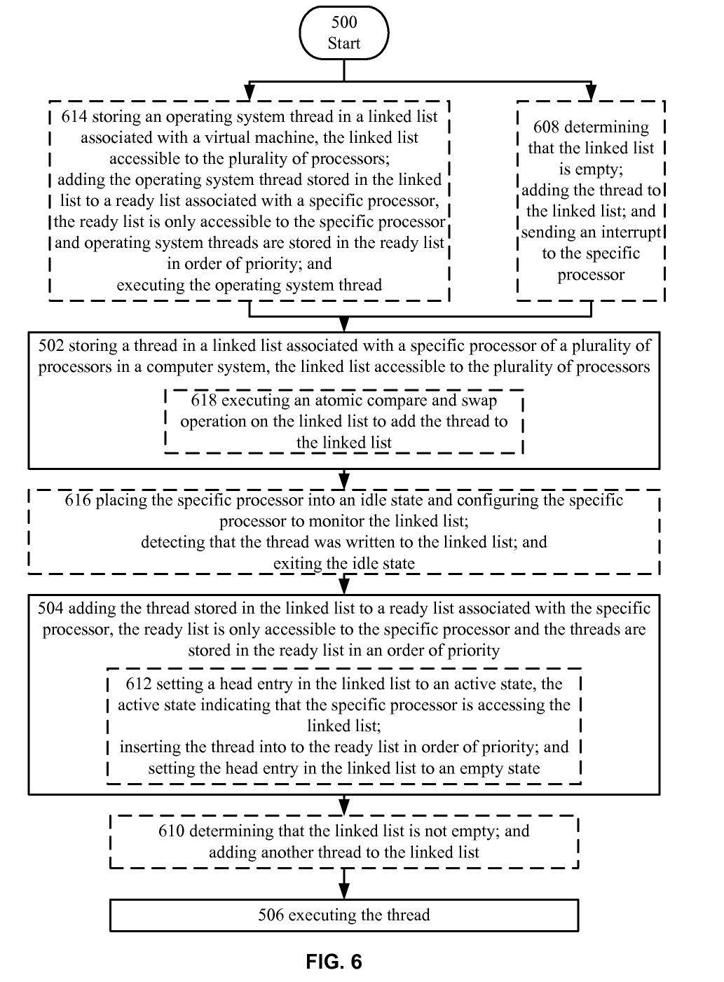

Turning now to FIG. 6, it illustrates an alternative embodiment of the operational procedure of FIG. 5 including additional operations 608-618. One skilled in the art can appreciate that the additional operations are illustrated in dashed lines which indicates that they are considered operation. Turning to operation 608 it shows determining that the linked list is empty; adding the thread to the linked list; and sending an interrupt to the specific processor. For example, in an embodiment the scheduler instructions can be executed by logical processor 102A and the processor can determine that linked list 418 associated with processor 102C for example, is empty and, in addition to adding thread 404, processor 102A can send an interrupt to processor 102C. For example, logical processor 102A can determine that linked list 426 is empty, e.g., it does not have any nodes that contain threads, and can generate a node having information for thread 404, link it to the head of linked list 426, e.g., to a node containing null, and send an interrupt to processor 102C. In this example the scheduler instructions can configure logical processor 102A to send an interrupt to logical processor 102C whenever linked list 426 is empty and a thread is added. Logical processor 102C may execute scheduler instructions when it receives the interrupt and determine that thread 404 was added to link list 426. In this example, since scheduler 400 is a lockless scheduler that uses linked lists and ready lists, logical processor 102C may not receive information that indicates that a thread has been added to link list 426 unless an interrupt was sent when the linked list transitioned from null to including a thread.

Continuing with the description of FIG. 6, operation 610 illustrates determining that the linked list is not empty; and adding another thread to the linked list. For example, logical processor 102A, for example, can be configured by scheduler instructions to determine that linked list 426 is not empty, e.g., it already includes thread 406, and processor 102A can be configured to add thread 406 to linked list 426. In this example linked list 426 may already have thread 404 stored in the linked list and, in an embodiment, an interrupt may have already been sent to logical processor 102C. Thus, the interrupt may not be needed in this example due to the fact that logical processor 102C has already been notified that a thread has been added to link list 426. Instead, logical processor 102A can merely add a node to the head that includes information for thread 406. In this example linked list 426 could have at least 3 nodes, node 1 would include information for thread 406; node 2 would include information for thread 404; and node 3 would be ‘null.’

Continuing with the description of FIG. 6, shows an embodiment where operation 504 includes operation 612 which depicts setting a head entry in the linked list to an active state, the active state indicating that the specific processor is accessing the linked list; inserting the thread into to the ready list in order of priority; and setting the head entry in the linked list to an empty state. For example, and referring to FIG. 4, logical processor 102C for example, can access linked list 426 and move the threads in linked list 426 to ready list 418. While logical processor 102C is accessing linked list 426 logical processor 102C can add a node to the head which indicates to other processors, e.g., logical processor 102A or B, that logical processor 102C is accessing linked list 426. In a specific example, embodiment the ‘active’ value can be a non-null value. In this example processor 102C can insert the threads retrieved from linked list 426 into ready list 418 in order of priority. After the threads have been added the logical processor 102C can be configured by scheduler instructions to set the head entry in the linked list 426 to ‘null’ before exiting.

In a specific example, the active state can be detected by other processors, e.g., logical processor 102A or B, that may attempt to add threads to linked list 426 and since ‘active’ is a non-null value, the other processors can add threads without sending an interrupt. Prior to existing logical processor 102C can execute instructions that check to see if the head value for link list 426 is still set to ‘active.’ In the instance that it has been changed, e.g., by another processor that adds a thread, then logical processor 102C can process link list 426 again and insert the newly added threads into the ready list 416.

Continuing with the description of FIG. 6, operation 614 illustrates storing an operating system thread in a linked list associated with a virtual machine, the linked list accessible to the plurality of processors; adding the operating system thread stored in the linked list to a ready list associated with a specific processor, the ready list is only accessible to the specific processor and operating system threads are stored in the ready list in order of priority; and executing the operating system thread. For example, and referring to FIG. 2 or 3, in an embodiment guest operating system 220 and/or 222 can include scheduler 400 and the associated data structures. In this case, the data structures indicative of the linked lists and the ready lists can be associated with virtual machine 240 or 242 and stored in RAM 104 assigned to virtual machines 240 and/or 242. The scheduler 400 in this example can include instructions that can be executed by, for example, logical processor 102A, running virtual processor 230A, which can add threads associated with guest operating system 220 to linked list 422. In this example logical processor 102B, running virtual processor 230B, can access linked list 422 and can add the guest operating system threads to ready list 416. Logical processor 102B can then execute the guest operating system thread.

Continuing with the description of FIG. 6, operation 616 illustrates placing the specific processor into an idle state and configuring the specific processor to monitor the linked list; detecting that the thread was written to the linked list; and exiting the idle state. In an embodiment, and referring to FIG. 4, logical processor, for example, logical processor 102C can be placed in an idle, e.g., low power, state. In this example, logical processor 102C can run code prior to entering the idle state that configures it to monitor linked list 426 while in idle mode. For example, a memory address associated with the head value can be monitored. In this example when a write on the memory address occurs logical processor 102C can detect it; exit from idle; and execute instructions that configure processor 102C to access linked list 426. In this example and prior to entering an idle state, logical processor 102C can add a node to linked list 426 which indicates that it is going to enter the idle state. In a specific example the value that indicates an idle state can be non-null. If another processor, logical processor 102A for example, adds to linked list 426 it can detect, from the head node, that the processor is idle or, in a specific embodiment, that it is not-empty. In this example, instead of adding a thread and sending an interrupt, logical processor 102A can just add a node to linked list 426.

Continuing with the description of FIG. 6, operation 618 illustrates an embodiment where operation 502 includes executing an atomic compare and swap operation on the linked list to add the thread to the linked list. For example, in an embodiment processor instructions that perform an atomic compare and swap operation can be used to add threads to a linked list. Since ordering of the link list is not a concern, locks do not need to be used to atomically access the list. Instead, a compare and swap operation can be used to schedule threads and a more sophisticated algorithm, used to insert threads into the middle of a ready list, does not have to be used.

Generally, an atomic compare and swap operation is performed on a target memory address. The processor executing the scheduler 400 can specify an expected value and a value to swap (swap value). If the value in the memory address is equal to the expected value it can be atomically switched to the swap value. If the expected value is not returned the operation can fail. A side effect of the compare and swap operation is that the executing processor can receive back the current value of the target memory address. In the event that the operation fails, the processor can execute scheduler instructions that configure the processor to compare and swap again using the current value as the expected value. When the compare and swap operation is successful, the new value can be placed in the head node of the linked list.

Referring to FIG. 4, the compare and swap operation can be used by a logical processor, logical processor 102B for example, to determine whether an interrupt needs to be sent to the processor associated with a linked list, logical processor 102A for example. Logical processor 102B can execute a compare and swap operation on the memory address associated with the head node in linked list 420. In a specific embodiment the operation can specify ‘null’ as the expected value and specify the memory address associated with thread 404 as the swap value. If the head node is empty, the operation can succeed and thread 404 can be placed on the linked list 420 as the head. In this example, logical processor 102B the scheduler instructions can configure processor 102B to send an interrupt to logical processor 102A. If, on the other hand, the operation failed, then link list 420 is not empty, i.e., it has a thread on it, processor 102A is actively accessing it, or processor 102A is idle, and an interrupt is unnecessary. Thus, logical processor 102B can be configured to execute a compare and swap operation to add thread 404 to linked list 420 using the returned value as the expected value and exit.

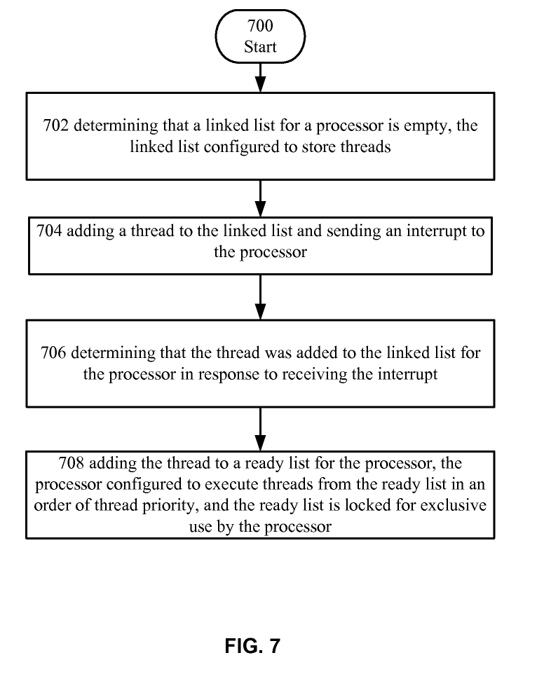

Turning now to FIG. 7, it illustrates an operational procedure for practicing aspects of the present disclosure including operations 700, 702, 704, 706, and 708. Operation 700 begins the operational procedure and operation 702 shows determining that a linked list for a processor is empty, the linked list configured to store threads. For example, and referring to FIG. 4 logical processor 102C for example, can execute scheduler instructions and determine to add a thread, thread 406 to linked list 420. In this example, processor 102C can determine that linked list 420 is empty by, for example, accessing the linked list and reading the value of the header node. In another embodiment, processor 102C could execute a compare and swap operation such as is described with respect to operation 618. If the operation succeeds, then processor 102C can determine that linked list 420 is empty.

Continuing with the description of FIG. 7, operation 704 illustrates adding a thread to the linked list and sending an interrupt to the processor. For example, and again referring to FIG. 4, processor 102C can execute scheduler instructions and add thread 406 to linked list 420. In an embodiment thread 404 can be added to linked list 420 using a write operation. That as, processor 102C can add a new node to the list; set the new node as the header node and store thread 404 in the header node. In another embodiment the compare and swap operation can be used to determine whether the list is empty and add a new node to the list.

Continuing with the example, since linked list 420 was previously empty scheduler instructions that configure logical processor 102C to send an interrupt to processor 102A can be executed. The interrupt can indicate that a thread was added to linked list 420. Similar to the examples described above, the scheduler instructions can configure logical processor 102C to send an interrupt to logical processor 102A whenever a thread was added is added to an empty linked list.

Referring to operation 706, it depicts determining that the thread was added to the linked list for the processor in response to receiving the interrupt. Continuing with the example described above, logical processor 102A may be configured to check linked list 420 for pending threads when it receives the interrupt. Otherwise, processor 102A may idle, execute hypervisor instructions, execute threads from ready list 416, etc. In this example logical processor 102A may need to be interrupted because the newly added thread may be the highest priority thread for logical processor 102A to execute at the time.

Continuing with the description of FIG. 7, operation 708 illustrates adding the thread to a ready list for the processor, the processor configured to execute threads from the ready list in an order of thread priority, and the ready list is exclusively accessible by the processor. Referring again to FIG. 4 logical processor associated with linked list 420, e.g., logical processor 102A, can access linked list 420 and insert thread 406 into ready list 414 based on its priority relative to any other threads on ready list 414 or any other threads obtained from linked list 420. For example, logical processor 102A can execute scheduler instructions and identify the priority of the threads in ready list 414. Logical processor 102A can then insert thread 404 into the list behind higher priority threads and in front of lower priority threads. In a specific situation, thread 406 may be the highest priority thread compared to other threads in ready list 414 and can be inserted into position 1 on ready list 414.

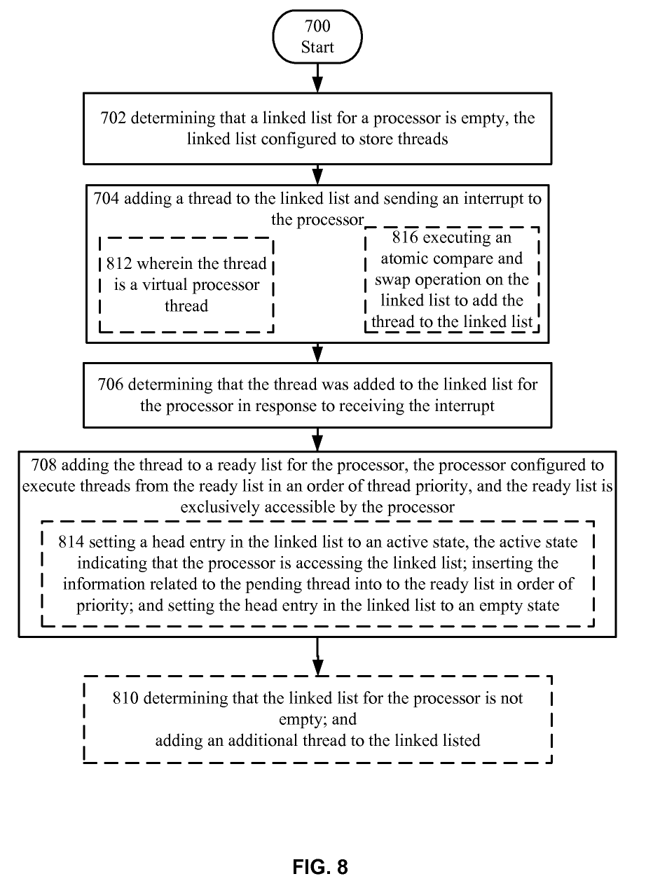

FIG. 8 shows an alternative embodiment of the operational procedure of FIG. 7 including additional operations 810-816. Operation 810 illustrates determining that the linked list for the processor is not empty; and adding an additional thread to the linked list. For example, and referring to FIG. 4, processor 102B can attempt to add another thread to linked list 420 such as thread 408. In this example, processor 102B can determine that linked list 420 includes thread 406, for example, accessing the linked list and reading the value of the header node in linked list 420 or by executing a compare and swap operation. The compare and swap operation will fail in any situation where the expected value does not mach the current value. Thus, in an example embodiment, if the expected value was ‘null’ and the operation fails, then processor 102B can determine that linked list 420 includes a non-zero value such as, a thread, a value that indicates that processor 102A is accessing linked list 420, that processor 102A is idle, etc. In this example since the head node includes a value an interrupt has already been sent to processor 102A and thus, another interrupt is unnecessary.

Continuing with the description of FIG. 8, operation 812 illustrates that in an embodiment the thread is a virtual processor thread. For example, scheduler instructions can be integrated within a hypervisor 202. In this example virtual processors in virtual machines can be treated as threads by the hypervisor 202 and can be scheduled to run on logical processors.

Turning now to operation 814, it illustrates setting a head entry in the linked list to an active state, the active state indicating that the processor is accessing the linked list; inserting the information related to the pending thread into the ready list in order of priority; and setting the head entry in the linked list to an empty state. For example, and referring to FIG. 4, logical processor 102A, can access linked list 420 and insert the threads into ready list 414. While logical processor 102A is accessing linked list 420, logical processor 102A can add a node to the head which indicates to other processors, e.g., logical processor 102B, C, etc., that logical processor 102A is accessing linked list 420. In this example processor 102A can insert the threads retrieved from linked list 420 into the ready list 414 in order of priority. After the threads have been added the logical processor 102A can be configured by scheduler instructions to set the head entry in the linked list 420 to ‘null’ before exiting.

In a specific example, the ‘active’ value can be a non-null sentinel value of the same length as a thread's memory address. In this example, if another logical processor, 102C for example, attempts to add a thread to linked list 420 using a compare and swap operation, logical processor 102C will detect the non-null value and add threads to the linked list without sending an interrupt. In another specific example, logical processor 102C can read the header value and determine that processor 102A is accessing the list. In this case hypervisor instructions can be executed that direct logical processor 102C to add the thread without sending an interrupt.

Operation 816 depicts executing an atomic compare and swap operation on the linked list to add the thread to the linked list. Similar to operation 616, in an embodiment processor instructions that execute an atomic compare and swap operation can be used to add threads to a linked list.

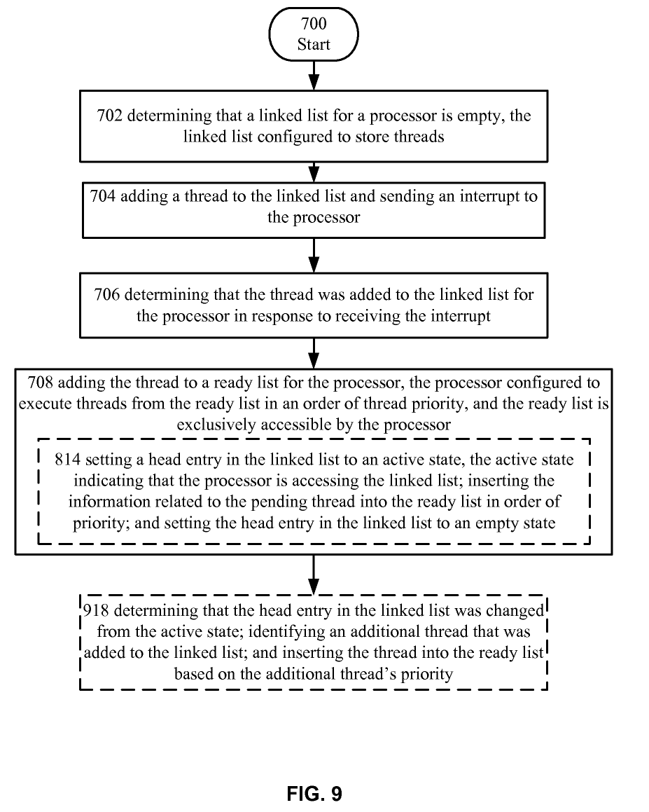

Turning now to FIG. 9, it depicts an alternative embodiment of the operational procedure of FIG. 8 including the operation 918 which illustrates determining that the head entry in the linked list was changed from the active state; identifying an additional thread that was added to the linked list; and inserting the thread into the ready list based on the additional thread's priority. In an embodiment when logical processor 102A attempts to exit the linked list 420, the scheduler instructions can configure the logical processor 102A attempt to set the header value from ‘active’ to ‘null.’ If, for example while logical processor 102A was inserting threads from link list 420 into ready list 414 and logical processor 102C for example added thread 408, the header value would not longer be set to ‘active.’ Logical processor 102A can determine that additional threads have been added to linked list 420. In this case, logical processor 102A can be configured by scheduler instructions to set the head node back to ‘active’ and process linked list 420 again to move the newly added threads to ready list 414.

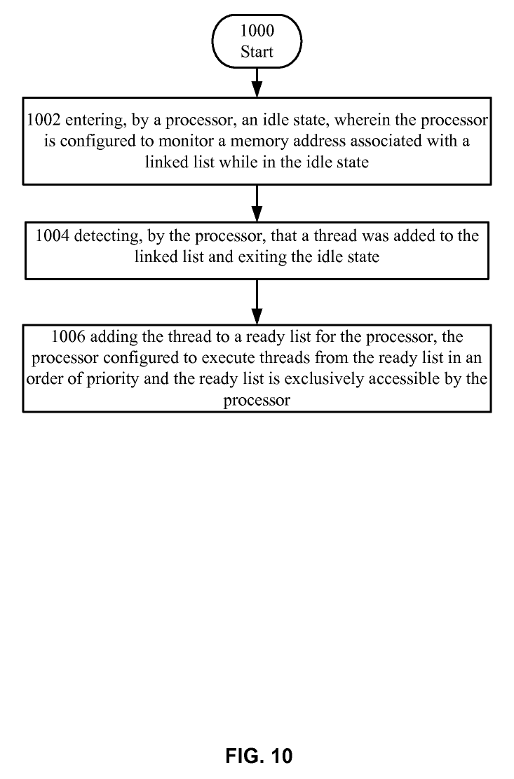

Referring to FIG. 10, it depicts an operational procedure for practicing aspects of the present disclosure including operations 1000, 1002, 1004, 1006, and 1008. Operation 1000 begins the operational procedure and operation 1002 shows entering, by a processor, an idle state, wherein the processor is configured to monitor a memory address associated with a linked list while in the idle state. For example, certain x86 processors can include a hardware feature that configures the processor to enter an idle state where it monitors a memory address. In the event that the memory address is written to the processor can exit from idle and execute predetermined code. In an embodiment logical processor, for example, logical processor 102B can include such a feature and can be placed in an idle, e.g., low power, state. In this example, logical processor 102B can enter the idle state when, for example, there are currently no threads for it to execute, e.g., link list 420 and ready list 414 are empty. Prior to entering the idle state the scheduler instructions can configure logical processor 102B to monitor linked list 422. For example, a memory address associated with linked list 422 such as the memory address associated with the head value can be monitored.

Continuing with the description of FIG. 10, operation 1004 shows detecting, by the processor, that a thread was added to the linked list and exiting the idle state. Once logical processor 102B is placed in an idle state it can consume less power. In this example, if a write on the memory address occurs, logical processor 102B can exit from idle and execute instructions that configure the processor 102B to, for example, access linked list 422. In a specific example embodiment logical processor 102B can add a value to the header node of link list 422 which indicates that it is going to enter the idle state. If another processor, logical processor 102A for example, adds thread 408 to linked list 422 it can detect that logical processor 102A is idle from the header node's value and just add a thread to the linked list 422 without sending an interrupt. That is, since logical processor 102A detects that logical processor 102B is idle any write that occurs on linked list 422 will cause logical processor 102B to exit idle mode and access linked list 422.

Continuing with the description of FIG. 10, operation 1006 shows adding the thread to a ready list for the processor, the processor configured to execute threads from the ready list in an order of priority and the ready list is exclusively accessible by the processor. Logical processor 102B can exit the idle state and access linked list 422. Logical processor 102B can then determine that thread 408 was added to the linked list and insert thread 408 into ready list 416 based on its priority relative to any other threads that may have been placed on link list 422. In an example situation, thread 408 may be the highest priority thread compared to other threads in ready list 416 and can be inserted into position 1.

Once thread 408 has been added to ready list 416, logical processor 102B can exit the linked list 422 and begin to execute threads on the ready list 416. Thread 408 may have been the highest thread inserted into ready list 416, thus, it could be executed after exiting the linked list 422. In another situation thread 408 could have been added along with thread 410 and 412. In this case thread 410 may have the highest priority followed by thread 412 and then thread 408. In this example scheduler instructions can be executed by logical processor 102B and the processor may insert thread 410 into position 1; thread 412 into position 2; and thread 408; into position 3. In this case logical processor 102B may then execute threads 410 and 412 before it executes thread 408.

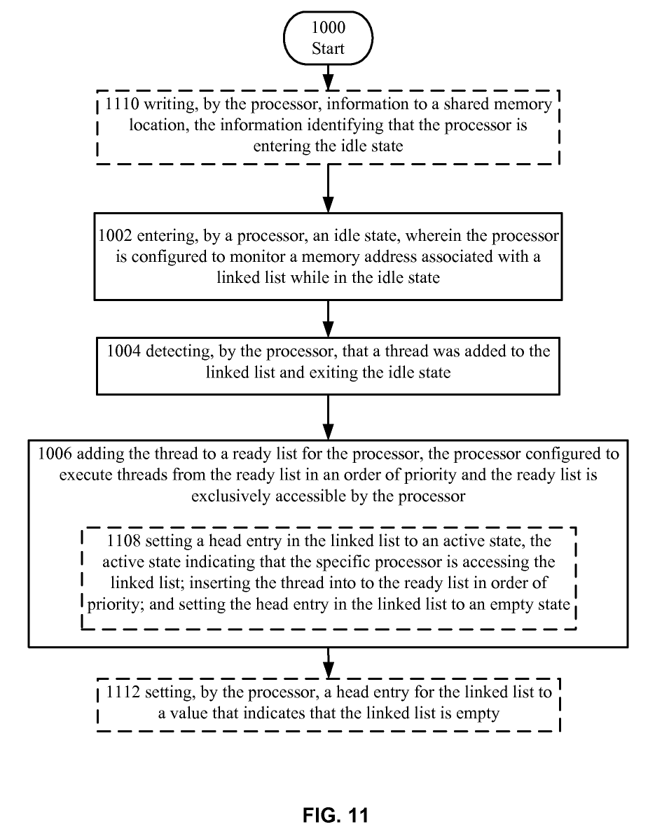

Turning now to FIG. 11, it depicts an alternative embodiment of the operational procedure of FIG. 10 including additional operations 1108, 1110, and 1112. Operation 1108 depicts setting a head entry in the linked list to an active state, the active state indicating that the specific processor is accessing the linked list; inserting the thread into to the ready list in order of priority; and setting the head entry in the linked list to an empty state. In an embodiment when logical processor 102B attempts to exit linked list 422 the scheduler instructions can configure the logical processor 102B to set the header value from ‘active’ to ‘null.’ If, for example, while logical processor 102B was inserting threads into ready list 416 logical processor 102C for example added a thread, the header value would not longer be set to ‘active’ and logical processor 102B can determine that additional threads have been added to linked list 422. In this case, logical processor 102B can be configured by scheduler instructions to set the head node back to ‘active’ and process linked list 422 again.

Continuing with the description of FIG. 11, operation 1110 shows writing, by the processor, information to a shared memory location, the information identifying that the processor is entering the idle state. For example, prior to entering the idle state processor 102B can update a state map 426. In an embodiment the state map 426 can be a shared memory location that can be accessed by each processor. In a specific example, the state map 426 can include a bitmap that can be accessed by logical processors in order to update their status. For example, logical processor 102B can execute scheduler instructions and can be configured to set a bit which indicates to other processors that it is entering the idle state.

This information can be used by the other processors, e.g., processor 102A or 102C when they execute scheduler instructions and attempt to schedule a thread from pending thread list 428. For example, the scheduler algorithm can be set to attempt to schedule threads on ideal processors, e.g., processors that have be used to run threads from a certain processor before. This increases efficiently due to cache locality. If, for example, an ideal processor is unavailable, e.g., it is busy executing other threads, the scheduler instructions can configure the processor executing them to search for an idle processor. In this case the state map 426 can be checked and it can be determined that processor 102B is idle. In this case a thread can be scheduled on the idle processor and processor 102B can exit idle mode and access link list 422.

Operation 1112 illustrates setting, by the processor, a head entry for the linked list to a value that indicates that the linked list is empty. In an embodiment processor 102B can execute scheduler instructions and set the header node to null. If another processor, processor 102A for example, executes scheduler instructions and determines to schedule a thread, e.g., thread 410, on linked list 422, processor 102A can determine that link list 422 is empty and can send an interrupt to processor 102B.

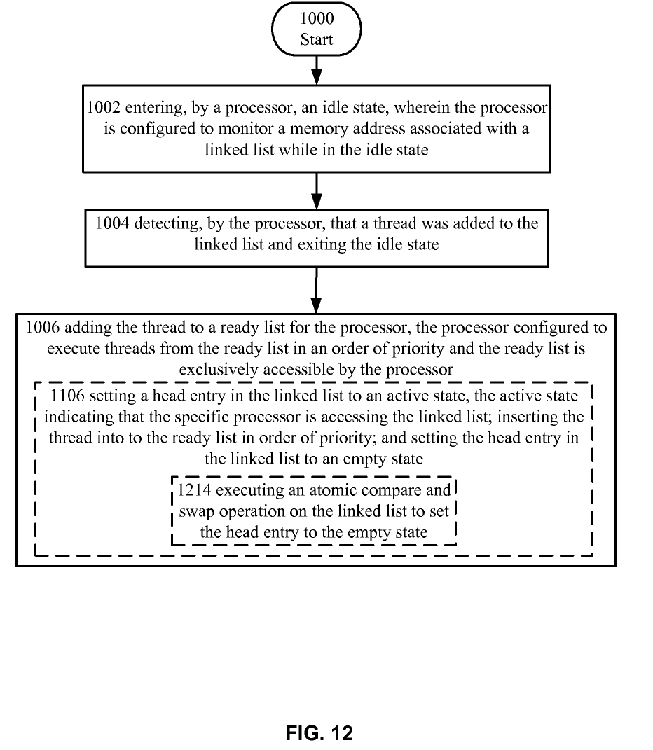

Turning now to FIG. 12, it depicts an alternative embodiment of the operational procedure of FIG. 11 including operation 1214 which illustrates executing an atomic compare and swap operation on the linked list to set the head entry to the empty state. For example, processor instructions that execute an atomic compare and swap operation can be used to set the header value of the link list to null. After processor 102B processes link list 422 and moves and threads to ready list 416, a compare and swap operation can be used to set the link list 422 header back to null. In this example, the expected value of the list can be set to ‘active.’ If the operation fails, that is, if processor 102A or 102C added threads to link list 422, then the processor 102B can execute instructions that direct it to set the header again to ‘active’ and process the link list. Processor 102B can continue through this loop until the compare and swap operation succeeds. That is, until no more threads are added while processor 102B is accessing link list 422.

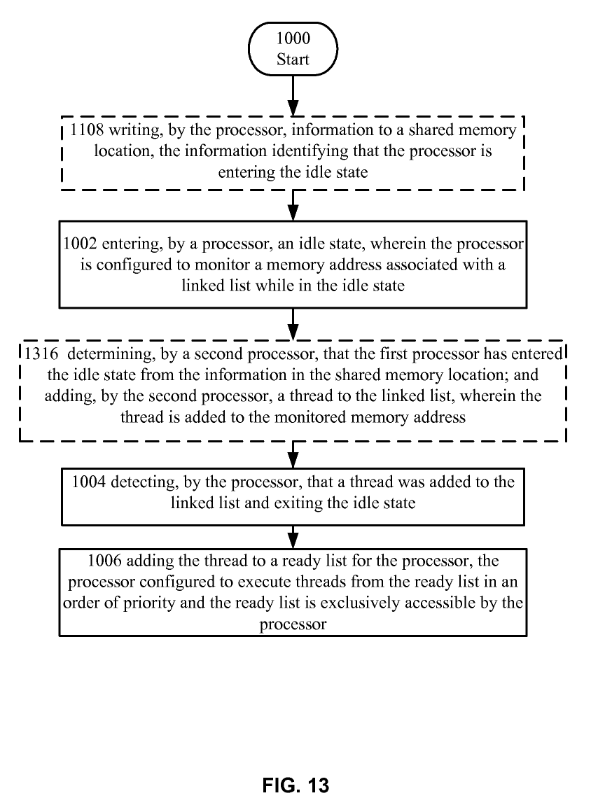

Turning now to FIG. 13, it depicts an alternative embodiment of the operational procedure of FIG. 11 including operation 1316 which illustrates determining, by a second processor, that the first processor has entered the idle state from the information in the shared memory location; and adding, by the second processor, a thread to the linked list, wherein the thread is added to the monitored memory address. For example, processor 102A can execute scheduler instructions and be configured to determine that processor 102B has entered the idle state. For example, the scheduler instructions can configure processor 102A to check state map 426 which can contain the status of each processor in the computer system 100, 200, or 300. Processor 102A can be configured to read bitmap 426 and determine that processor 102B is idle. In this example the scheduler instructions can configure processor 102A to schedule a thread, thread 410 for example, on link list 422. In an embodiment scheduler 400 can include a policy that directs it to schedule threads on idle processors before processors that are executing threads for example.

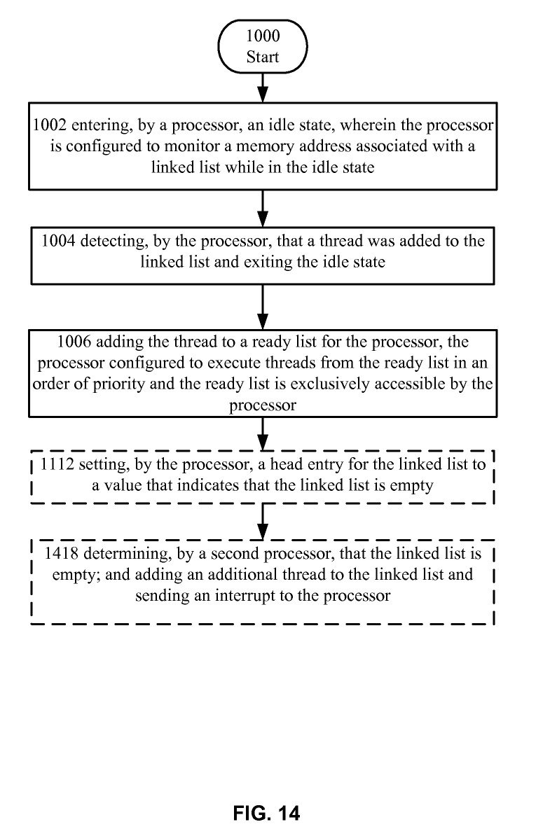

Turning now to FIG. 14, it depicts an alternative embodiment of the operational procedure of FIG. 11 including operation 1418 which illustrates determining, by a second processor, that the linked list is empty; and adding an additional thread to the linked list and sending an interrupt to the processor. For example, after processor 102B sets the header value to null, another processor 102C for example can be configured to scheduler a thread, thread 412, on link list 422. In this example, processor 102C can execute scheduler instructions and add thread 412 to linked list 422. In a specific example, adding a thread to a linked list can include processor 102C adding the memory address for thread 412 and/or its priority to a linked list. In an embodiment thread 412 can be added to linked list 422 using a write operation. That as, processor 102C can add a new node to the list; set the new node as the header node and store thread 412 in the header node. In another embodiment the compare and swap operation can add a new node to the list; set the new node as the header node and store thread 412 in the header node.

Continuing with the example, since the linked list was previously empty an interrupt can be sent to processor 102B. The interrupt can indicate that a thread was added to linked list 422. Similar to the examples described above, the scheduler instructions can configure logical processor 102C to send an interrupt to logical processor 102B whenever a thread was added is added to an empty linked list.

The foregoing detailed description has set forth various embodiments of the systems and/or processes via examples and/or operational diagrams. Insofar as such block diagrams, and/or examples contain one or more functions and/or operations, it will be understood by those within the art that each function and/or operation within such block diagrams, or examples can be implemented, individually and/or collectively, by a wide range of hardware, software, firmware, or virtually any combination thereof.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein.

What is claimed is:

1. A computer readable storage medium including processor executable instructions, the computer readable storage medium comprising:
instructions for storing a thread in a linked list associated with a specific processor of a plurality of processors in a computer system, the linked list accessible to the plurality of processors;
instructions for adding the thread stored in the linked list to a ready list associated with the specific processor, the ready list is only accessible to the specific processor and the threads are stored in the ready list in an order of priority; and
instructions for executing the thread.

2. The computer readable storage medium of claim 1, further comprising:
instructions for determining that the linked list is empty;
instructions for adding the thread to the linked list; and
instructions for sending an interrupt to the specific processor.

3. The computer readable storage medium of claim 1, further comprising:
instructions for determining that the linked list is not empty; and
instructions for adding another thread to the linked list.

4. The computer readable storage medium of claim 1, wherein the instructions for adding the thread stored in the linked list to the ready list further comprises:
instructions for setting a head entry in the linked list to an active state, the active state indicating that the specific processor is accessing the linked list; and
instructions for inserting the thread into to the ready list in order of priority;
instructions for setting the head entry in the linked list to an empty state.

5. The computer readable storage medium of claim 1, further comprising:
instructions for storing an operating system thread in a linked list associated with a virtual machine, the linked list accessible to the plurality of processors;
instructions for adding the operating system thread stored in the linked list to a ready list associated with a specific processor, the ready list is only accessible to the specific processor and operating system threads are stored in the ready list in order of priority; and
instructions for executing the operating system thread.

6. The computer readable storage medium of claim 1, further comprising:
instructions for placing the specific processor into an idle state and configuring the specific processor to monitor the linked list;
instructions for detecting that the thread was written to the linked list; and
instructions for exiting the idle state.

7. The computer readable storage medium of claim 1, wherein the instructions for storing the thread in the linked list further comprise:
instructions for executing an atomic compare and swap operation on the linked list to add the thread to the linked list.

8. A computer system, comprising:
circuitry for determining that a linked list for a processor is empty, the linked list configured to store threads;
circuitry for adding a thread to the linked list and sending an interrupt to the processor;
circuitry for determining that the thread was added to the linked list for the processor in response to receiving the interrupt; and
circuitry for adding the thread to a ready list for the processor, the processor configured to execute threads from the ready list in an order of thread priority, and the ready list is exclusively accessible by the processor.

9. The computer system of claim 8, further comprising:
circuitry for determining that the linked list for the processor is not empty; and
circuitry for adding an additional thread to the linked list.

10. The system of claim 8, wherein the thread is a virtual processor thread.

11. The system of claim 8, wherein the circuitry for adding the thread to the ready list further comprises:
circuitry for setting a head entry in the linked list to an active state, the active state indicating that the processor is accessing the linked list; and
circuitry for inserting the information related to the pending thread into the ready list in order of priority; and
circuitry for setting the head entry in the linked list to an empty state.

12. The system of claim 8, wherein the circuitry for adding the thread to the linked list further comprises:
circuitry for executing an atomic compare and swap operation on the linked list to add the thread to the linked list.

13. The system of claim 11, further comprising:
circuitry for determining that the head entry in the linked list was changed from the active state;
circuitry for identifying an additional thread that was added to the linked list; and
circuitry for inserting the thread into the ready list based on the additional thread's priority.

14. A method, comprising:
entering, by a processor, an idle state, wherein the processor is configured to monitor a memory address associated with a linked list while in the idle state;
detecting, by the processor, that a thread was added to the linked list and exiting the idle state; and
adding the thread to a ready list for the processor, the processor configured to execute threads from the ready list in an order of priority and the ready list is exclusively accessible by the processor.

15. The method of claim 14, wherein adding the thread to the ready list further comprises:
setting a head entry in the linked list to an active state, the active state indicating that the specific processor is accessing the linked list;
inserting the thread into to the ready list in order of priority; and
setting the head entry in the linked list to an empty state.

16. The method of claim 14, further comprising:
writing, by the processor, information to a shared memory location, the information identifying that the processor is entering the idle state.

17. The method of claim 14, further comprising:
setting, by the processor, a head entry for the linked list to a value that indicates that the linked list is empty.

18. The method of claim 15, wherein setting the head entry in the linked list to the empty state further comprises:
executing an atomic compare and swap operation on the linked list to set the head entry to the empty state.

19. The method of claim 16, further comprising:
determining, by a second processor, that the first processor has entered the idle state from the information in the shared memory location; and
adding, by the second processor, a thread to the linked list, wherein the thread is added to the monitored memory address.

20. The method of claim 17, further comprising:
determining, by a second processor, that the linked list is empty; and
adding an additional thread to the linked list and sending an interrupt to the processor.
